(19) United States
(12) Patent Application Publication
(10) Pub. No.: US 2013/0297659 A1
(43) Pub. Date: Nov. 7, 2013

(54) METHOD FOR DATA MANAGEMENT

(71) Applicants: Jer-Bin Lin, New Taipei City (TW); Shun-Li Huang, Kaohsiung City (TW); Chi-Ning Chen, New Taipei City (TW)

(72) Inventors: Jer-Bin Lin, New Taipei City (TW); Shun-Li Huang, Kaohsiung City (TW); Chi-Ning Chen, New Taipei City (TW)

(21) Appl. No.: 13/602,344

(22) Filed: Sep. 4, 2012

(30) Foreign Application Priority Data
May 3, 2012 (TW) 101115765

(51) Int. Cl. G06F 7/00; G06F 17/30

(52) U.S. Cl. 707/812; 707/E17.005

(57) ABSTRACT

A method for data management includes providing a data management platform with a plurality of data folders for storing data; the data management platform receiving and storing a plurality of data objects in the plurality of data folders, the plurality of data objects including uniform resource locator links, document files, audio/video streaming files and/or application software files; the data management platform capturing and storing opening page snapshots of the data objects when being opened; and when a terminal device links to the data management platform via a network for accessing a first data folder of the plurality of data folders, the terminal device displaying opening page snapshots of data objects stored in the first data folder.

### BACKGROUND OF THE INVENTION

1. Field of the Invention

The present invention relates to a method for data management, and more particularly, a method for data management that is capable of displaying opening page snapshots of data objects.

2. Description of the Prior Art

As related technology continues to evolve, the Internet already becomes a very important medium for data transmission. A user is able to send emails, chat online, upload files, download and share files and via the Internet. Current data management platform allows the user to sign up and create an account for managing data objects uploaded to the account or reading data objects shared by other accounts via the Internet. However, when the user utilizes a terminal device to log into the data management platform, the terminal device only display file formats and file names of the data objects, the user can not preview content of the data objects before opening the data objects, such that when the user tries to search for a required data object, the user must open the data objects one by one to confirm whether the content of the data object is useful to the user. But when opening the data object for preview purpose, the terminal device must first download the data object in full, then opens up the downloaded data object by its corresponding program. The above process consumes lots of time, especially when network bandwidth is limited. Therefore, the data management platform of the prior art is inconvenient to the user when managing or searching data objects.

### SUMMARY OF THE INVENTION

The present invention provides a method for data management. The method comprises providing a data management platform with a plurality of data folders for storing data; the data management platform receiving and storing a plurality of data objects in the plurality of data folders, the plurality of data objects comprising uniform resource locator (URL) links, document files, audio video/streaming files and/or application software files; the data management platform capturing and storing opening page snapshots of the data objects when being opened; and when a terminal device links to the data management platform via a network for accessing a first data folder of the plurality of data folders, the terminal device displaying open images of data objects stored in the first data folder.

In contrast to the prior art, the method for data management of the present invention captures and stores the opening page snapshots of the data objects when being opened to allow users to directly preview the opening page snapshot of the data objects when the terminal device is linked to the data management platform, and the terminal device can simultaneously display data objects stored in the plurality of sub data folders at different display areas, which is convenient to the user to manage or search data objects, and increases convenience during use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a storage structure of a data management platform of the present invention.

FIG. 2 is a diagram illustrating a terminal device of the present invention linking to the data management platform for accessing data folders.

FIG. 3 is a diagram illustrating the terminal device of the present invention linking to the data management platform for accessing sub data folders.

FIG. 4 is a flowchart showing a method for data management of the present invention.

### DETAILED DESCRIPTION

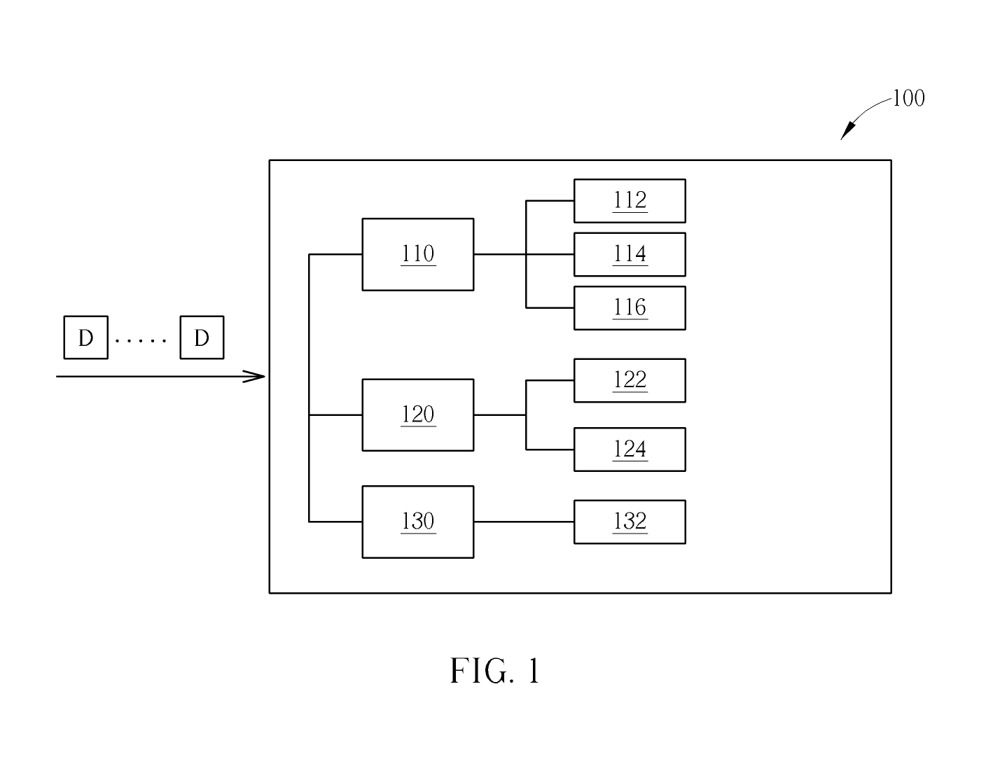

Please refer to FIG. 1. FIG. 1 is a diagram showing a storage structure of a data management platform of the present invention. As shown in FIG. 1, the data management platform 100 comprises a plurality of data folders 110, 120, 130. Each of the data folders 110, 120, 130 can further comprise a plurality of sub data folders 112, 114, 116, 122, 124, 132 for storing data objects. The data objects can be uniform resource locator (URL) links, document files, audio/video streaming files and/or application software files. The data folders 110, 120, 130 and the sub data folders 112, 114, 116, 122, 124, 132 can store different types of data objects or different data objects with different topics. When the data management platform 100 receives data objects D uploaded by a user and stores the data objects D in the data folders 110, 120, 130 or the sub data folders 112, 114, 116, 122, 124 assigned by the user, the data management platform 100 captures and stores opening page snapshot of the data objects D when being opened. For example, when the data object D is a URL link, the data management platform 100 can open a web page indicated by the URL link to capture and store an snapshot image of the web page; and when the data object D is a document file (such as a PDF file), an audio/video streaming file or an application software file, the data management platform 100 can open the file by a corresponding program to capture and store an opening page snapshot of the opened file (such as an image of a first page of the PDF file). Storage structure of the data management platform 100 of the present invention is not limited to only comprise a first layer with the data folders and a second layer with the sub data folders, the storage structure of the data management platform 100 of the present invention can comprise more layers according to requirement.

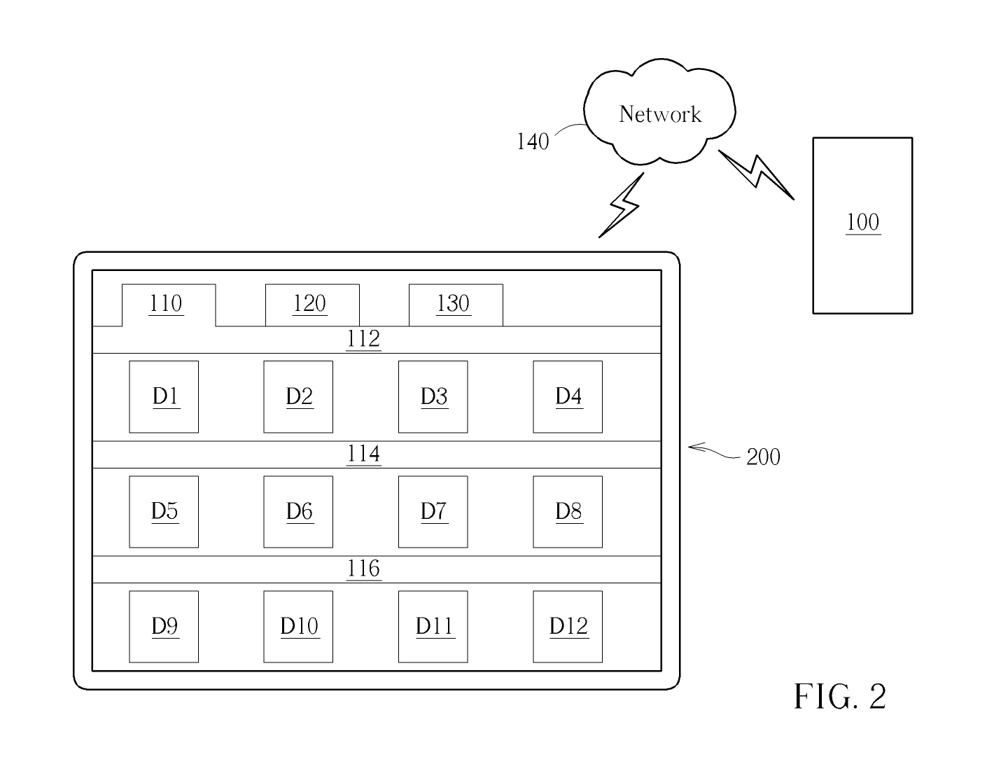

Please refer to FIG. 2, and refer to FIG. 1 as well. FIG. 2 is a diagram illustrating a terminal device of the present invention linking to the data management platform for accessing data folders. As shown in FIG. 2, when the terminal device 200 links to the data management platform 100 via a network 140 for accessing the data folder 110, the terminal device 200 simultaneously displays the plurality of sub data folders 112, 114, 116 and the data objects D1-D12 stored in the sub data folders 112, 114, 116 at different display areas, for allowing the user to easily review the data objects D1-D12 stored in the sub data folders 112, 114, 116 at a same time. Besides, the sub data folders 112, 114, 116 can slide left and right (or move in other way) for allowing the user to easily review other data objects stored in the sub data folders 112, 114, 116. In addition, when displaying the data objects D1-D12, the terminal device 200 displays the opening page snapshot of the data objects D1-D12, such that the user can easily and quickly review content of the data objects D1-D12 from the opening page snapshots of the data objects D1-D12, which is convenient to the user to manage or search data objects.

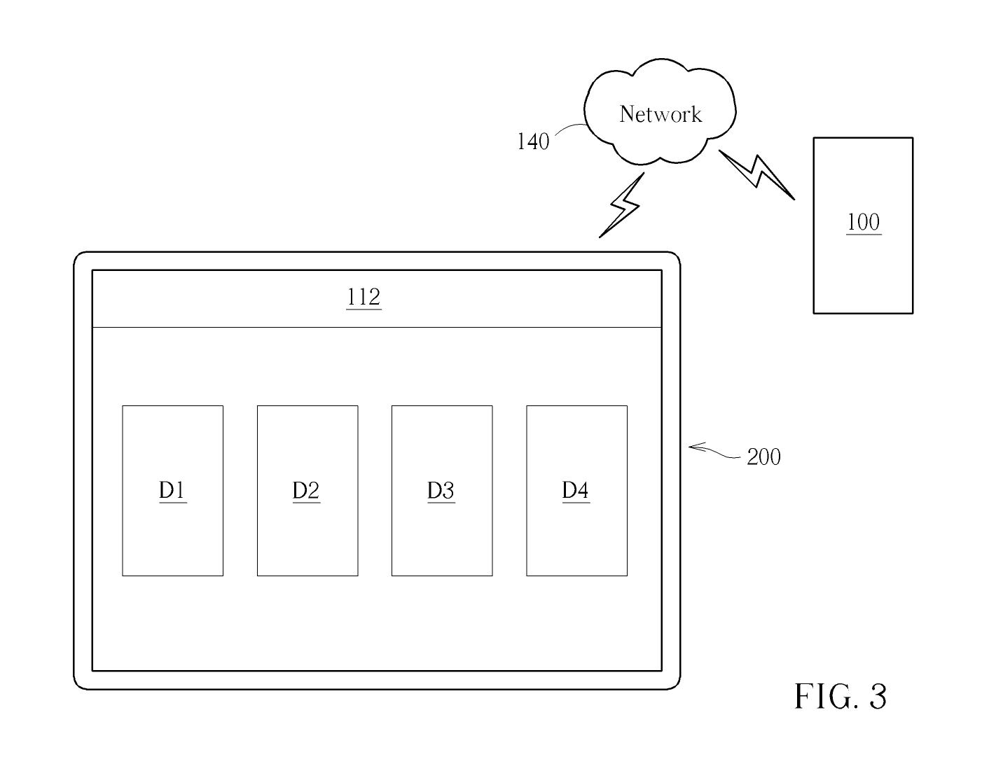

Please refer to FIG. 3, and refer to FIG. 1 and FIG. 2 as well. FIG. 3 is a diagram illustrating the terminal device of the present invention linking to the data management platform for accessing sub data folders. As shown in FIG. 3, when the user tries to access the sub data folder 112, the user can click on the sub data folder 112 shown in FIG. 2, such that the terminal device 200 can access the sub data folder 112 as shown in FIG. 3. In addition, the sub data folder 112 can also slide left and right (or move in other way) for allowing the user to easily review other data objects stored in the sub data folder 112. Similarly, when displaying the data objects D1-D4, the terminal device 200 displays the opening page snapshots of the data objects D1-D4, wherein the opening page snapshots of the data objects D1-D4 are further enlarged, such that the user can easily and quickly review content of the data objects D1-D4 from the opening page snapshots of the data objects D1-D4, which is convenient to the user to manage and to search for data objects.

According to the above arrangement, the user does not need to open the data objects D1-D12 one by one to know the content of the data objects D1-D12, so as to reduce searching time of demanded data objects. In addition, the user can click on the opening page snapshot of the required data object displayed on the terminal device 200 in order to open the data object. For example, when the data object D1 is a URL link, the terminal device 200 can utilize a web browser to open a web page indicated by the Internet address; and when the data object D1 is a document file, an audio/video streaming file or an application software file, the terminal device 200 can directly open the file or utilize a corresponding program to open the file. When the data object is opened, the user can edit the opened data object (such as editing the document file) by the terminal device 200, and then upload and store the edited data object in the data folder or the sub data folder of the data management platform 100. The data management platform 100 can further record an open time, a user account and a type corresponding to the data object when the terminal device 200 opens the data object.

Moreover, access permissions of the data folders 110, 120, 130 and the sub data folders 112, 114, 116, 122, 124, 132 can be pre-defined, such that the data folders 110, 120, 130 and the sub data folders 112, 114, 116, 122, 124, 132 are only accessible to the user account granted with a specific permission. The user can manage the data folders and the sub data folders corresponding to the permission via the terminal device 200, such as adding/deleting the data folder or the sub data folder, or uploading/deleting data objects. When the data management method of the present invention is applied to manage a plurality of user accounts of a department, the data management method of the present invention can set a functional permission of each role in the department, such that the user accounts corresponding to different roles have different functional permissions. The functional permissions comprise permissions of browsing, editing, deleting, adding, feedback and etc. For example, a role with a higher position (such as a manager) has a higher access permission, and a role with a lower position (such as an assistant) has a lower access permission, such that the data folders and the sub data folders possessed by the department are convenient to manage. When the data management method of the present invention is applied to manage a plurality of user accounts of different groups, the data management method of the present invention can respectively set the functional permissions of the user accounts of different groups in the data management platform 100, and the user accounts of different groups have different functional permissions, such that the data folders and the sub data folders possessed by a group can not be accessed by the user accounts of another group. The data management method of the present invention can further set the functional permission of each role in each group, such that the user accounts corresponding to different roles have different functional permissions, in order to conveniently manage the data folders and the sub data folders of different groups.

Therefore, when the data management method of the present invention is applied to online application platforms, convenience is increased during use. For example, when the data management method of the present invention is applied to an online shopping platform, the data management platform 100 can store URL links of merchandises of each category in the corresponding data folder, and the data management platform 100 then captures and stores the opening page snapshot of each of the merchandises' web pages. When the terminal device 200 utilizes application software executing the data management method of the present invention to link to the data management platform 100 via the network 140, a consumer can quickly preview the opening page snapshot of the web page of each of the merchandises, in order to know the description of the merchandise. The consumer can then determine whether to further open the web page of the merchandise for shopping. Therefore, the consumer does not need to open the merchandises' web pages one by one, which further increases convenience for online shopping.

When the data management method of the present invention is applied to an enterprise data management platform, the user can store the data objects with the same topic (such as URL links, document files, audio/video streaming files and/or application software files with the same topic) in the same data folder or sub data folder, and the data management platform 100 then captures and stores the opening page snapshot of each of the data objects. When the terminal device 200 utilizes the application software executing the data management method of the present invention to link to the data management platform 100 via the network 140, the user can quickly preview the opening page snapshots of the data objects with the same topic, in order to know the content of the data object. The user can determine whether to further open the data object. Therefore, the user does not need to open the data objects one by one, which further reduces volume and time of data downloaded. In addition, the user can edit the opened data object (such as editing the document file) via the terminal device 200, and then upload and store the edited data object in the data folder or the sub data folder of the data management platform 100, which is convenient for discussing with colleagues.

When the data management method of the present invention is applied to an online audio/video platform, the administrator of the data management platform 100 can store the audio/video streaming files of each category in the corresponding data folder, and the data management platform 100 then captures and stores the opening page snapshot of each of the audio/video streaming files (such as a real time image of the audio/video streaming file or a video clip with a predetermined length). When the terminal device 200 utilizes the application software executing the data management method of the present invention to link to the data management platform 100 via the network 140, the user can quickly preview the opening page snapshot of each of the audio/video streaming files, in order to know the content of the audio/video streaming file. The user can determine whether to further open the audio/video streaming file for watching. Therefore, the user does not need to open the audio/video streaming files one by one, which further increases convenience for watching audio/video streams online.

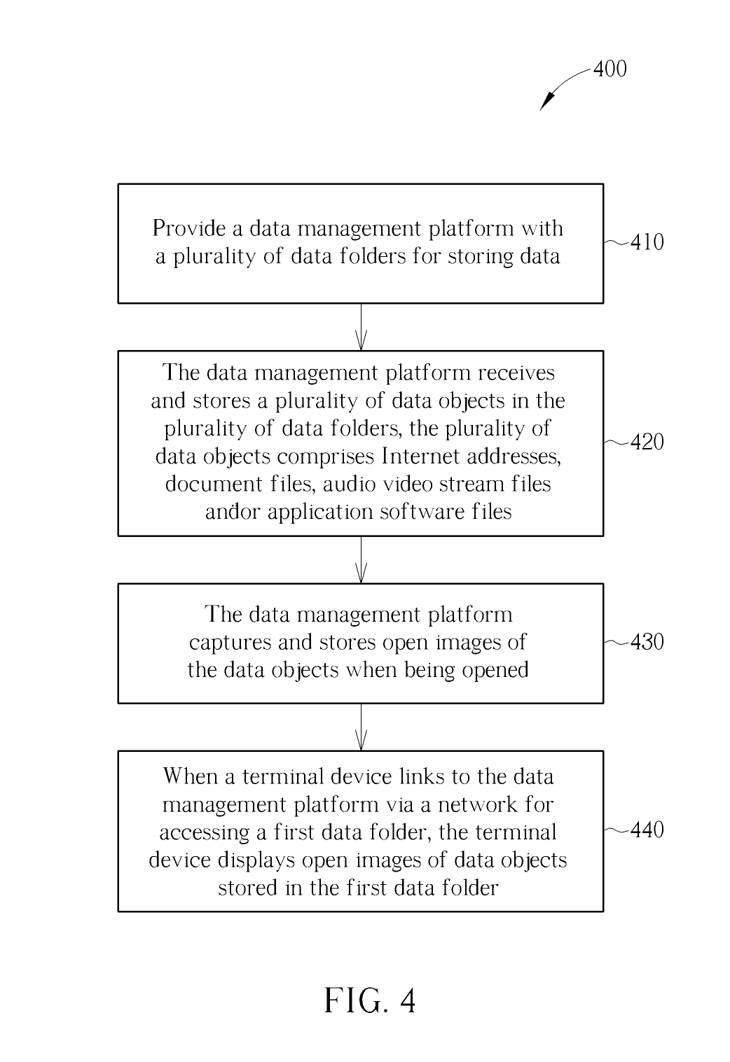

Please refer to FIG. 4. FIG. 4 is a flowchart 400 showing a method for data management of the present invention. The method for data management of the present invention comprises the following steps:

Step 410: Provide a data management platform with a plurality of data folders for storing data;

Step 420: The data management platform receives and stores a plurality of data objects in the plurality of data folders, the plurality of data objects comprises URL links, document files, audio/video streaming files and/or application software files;

Step 430: The data management platform captures and stores opening page snapshots of the data objects when being opened; and

Step 440: When a terminal device links to the data management platform via a network for accessing a first data folder, the terminal device displays opening page snapshots of data objects stored in the first data folder.

In contrast to the prior art, the method for data management of the present invention captures and stores the opening page snapshots of the data objects when being opened for allowing the user directly previewing the opening page snapshots of the data objects when the terminal device is linked to the data management platform, and the terminal device can simultaneously display data objects stored in the plurality of sub data folders at different display areas, which is convenient to the user to manage or search data objects, and increases convenience during use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for data management, comprising:
providing a data management platform with a plurality of data folders for storing data;
the data management platform receiving and storing a plurality of data objects in the plurality of data folders, the plurality of data objects comprising uniform resource locator (URL) links, document files, audio/video streaming files and/or application software files;
the data management platform capturing and storing opening page snapshots of the data objects when being opened; and
when a terminal device links to the data management platform via a network for accessing a first data folder of the plurality of data folders, the terminal device displaying opening page snapshots of data objects stored in the first data folder.

2. The method of claim 1 further comprising:
the terminal device selecting an opening page snapshot of a first data object stored in the first data folder; and
opening the first data object.

3. The method of claim 2, wherein when the first data object is a URL link, opening the first data object is opening a web page indicated by the URL link.

4. The method of claim 2, wherein when the first data object is a document file, an audio/video streaming file, or an application software file, opening the first data object is the terminal device directly opening the first data object.

5. The method of claim 2, wherein when the first data object is a document file, an audio/video streaming file, or an application software file, opening the first data object is opening the first data object by a corresponding program.

6. The method of claim 2 further comprising:
the terminal device editing the first data object; and
storing the edited first data object in the first data folder.

7. The method of claim 2 further comprising the data management platform recording opening time, a user account, and a category corresponding to the first data object when the terminal device opens the first data object.

8. The method of claim 2, wherein the first data folder comprises
a plurality of sub data folders for storing corresponding data objects; and
wherein the terminal device displaying opening page snapshots of data objects stored in the first data folder is the terminal device simultaneously displaying opening page snapshots of data objects stored in the plurality of sub data folders of the first data folder at different display areas.

9. The method of claim 1 further comprising setting functional permissions of the plurality of data folders.

10. The method of claim 1 further comprising the terminal device uploading a data object to a data folder of the data management platform.

11. The method of claim 1 further comprising adding a data folder in the data management platform.

12. The method of claim 1 further comprising setting functional permissions of a plurality of user accounts in the data management platform.

13. The method of claim 12 wherein setting functional permissions of a plurality of user accounts in the data management platform comprises setting functional permissions of a plurality of user accounts of a department in the data management platform, and wherein each of the user accounts corresponds to a role, and user accounts corresponding to different roles have different functional permissions.

14. The method of claim 12 wherein setting functional permissions of a plurality of user accounts in the data management platform comprises setting functional permissions of a plurality of user accounts of a plurality of groups in the data management platform, and wherein user accounts of different groups have different functional permissions.
